(19) United States
(12) Patent Application Publication
(10) Pub. No.: US 2022/0056280 A1
(43) Pub. Date: Feb. 24, 2022

(54) POWDER FLOWABILITY IMPROVEMENT

(71) Applicant: Braskem S.A., Camaçari (BR)

(72) Inventors: Alexandre da Luz, Triunfo (BR); Juliana Breda Soares, Triunfo (BR); Dillan Passos Bernardes, São Paulo (BR)

(73) Assignee: Braskem S.A., Camaçari (BR)

(21) Appl. No.: 17/409,505

(22) Filed: Aug. 23, 2021

Related U.S. Application Data
(60) Provisional application No. 63/068,642, filed on Aug. 21, 2020.

(51) Int. Cl. C09D 5/03; C09D 123/12; C09D 123/06; B29C 64/153; B33Y 10/00; B33Y 70/00

(52) U.S. Cl. CPC C09D 5/037; C09D 123/12; C09D 123/06; C08K 5/098; B33Y 10/00; B33Y 70/00; B29C 64/153

(57) ABSTRACT

A method of manufacturing an article using a powder bed fusion technique including depositing a first layer of a dry blend mixture on to a target surface, the dry blend mixture comprising a thermoplastic polymer powder and a stearate additive in a range of 2,000 ppm to 20,000 ppm; directing energy to the first layer of the dry blend mixture so as to melt and sinter at least portion of the first layer of the dry blend mixture; and successively depositing layers of the dry blend mixture and directing energy to the deposited layers so as to melt and sinter at least a portion of the successive layers to a prior layer to perform a layer-by-layer process until a three-dimensional structure is obtained.

### CROSS-REFERENCE TO RELATED APPLICATION

This application claims priority to U.S. Patent Application No. 63/068,642, filed on Aug. 21, 2020, which is herein incorporated by reference in its entirety.

### BACKGROUND

Additive manufacturing is an area of industrial production that encompasses various techniques used to build three-dimensional (3-D) objects at least one layer at a time. Different substances may be used in additive manufacturing, such as metal powder, thermoplastic polymer powder, ceramics, composites, glass, and even edible substances.

Selective Laser Sintering (SLS) is a type of powder bed fusion in the area of additive manufacturing wherein 3-D objects are created by selectively sintering layers of powder material. SLS typically involves the use of a direct energy source, such as a high power laser or directed thermal energy, to fuse small particles, typically comprising of thermoplastic polymers, into a desired 3-D shape. The laser selectively fuses the powdered material by scanning cross-sections generated from a 3-D digital description of the part, for example from a CAD file or scan data, on the surface of a powder bed. After each cross-section is scanned, the powder bed is lowered by the thickness of one layer, a new layer of material is applied on top, and the process is repeated until the desired 3-D object is complete.

SLS technology is often utilized in industrial applications for a broad array of manufacturing segments such as automotive, aerospace, and packaging. SLS technology is most commonly known and used in areas of innovation, as it is a cost effective way to build a wide variety of prototypes in a timely manner.

Despite the wide use of various powder materials in additive manufacturing, there remains a need in the art for powder material to achieve optimized powder properties, in particular, powder flowability. Powder flowability refers to how a given material moves under conditions present in manufacturing equipment. Additives are often incorporated in the powder material as a way to improve the flowability characteristics of the powder. This incorporation of additives has to be carefully considered in order to have a desired effect on the powder flowability. Improved flowability characteristics relative to flowability of existing powders used in additive manufacturing can enhance the characteristics of the overall powder composition, as well as the desired characteristics of the final 3-D product, or article.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method of manufacturing an article using a powder bed fusion technique that includes depositing a first layer of a dry blend mixture on to a target surface, the dry blend mixture comprising a thermoplastic polymer powder and a stearate additive in a range of 2,000 ppm to 20,000 pp, directing energy to the first layer of the dry blend mixture so as to melt and sinter at least a portion of the first layer of the dry blend mixture, successively depositing layers of the dry blend mixture and directing energy to the deposited layers so as to melt and sinter at least a portion of the successive layers to a prior layer to perform a layer-by-layer process until a three-dimensional structure is obtained.

In another aspect, embodiments disclosed herein relate to a method of improving flowability of a thermoplastic polymer powder, including dry blending an amount of stearate additive ranging from 2,000 to 20,000 ppm with a thermoplastic polymer powder to produce a dry blend mixture; and causing the dry blend mixture to flow.

In another aspect, embodiments disclosed herein relate to a dry blend powder with improved flowability for powder bed fusion, including a thermoplastic polymer powder, and a stearate additive in a range of 2,000 to 20,000 ppm.

Other aspects and advantages of the claimed subject matter will be apparent from the following description and the appended claims.

### BRIEF DESCRIPTION OF DRAWINGS

FIG. 1 is a schematic of a selective laser sintering system used in embodiments of the present disclosure.

FIGS. 2-5 show flow of thermoplastic polymer powders with increasing amounts of calcium stearate dry blended with the polymer powder.

### DETAILED DESCRIPTION

Generally, embodiments disclosed herein relate to methods of increasing the flowability of thermoplastic polymer powder with the addition via dry blend of a stearate additive, thereby optimizing the integrity and quality of the article created by the laying technique of additive manufacturing. In particular, powder compositions of the present disclosure improved flowability, making the powders suitable for use in powder-based additive manufacturing techniques, which necessitate a consistent thin layer of powder applied to produce a consistent article.

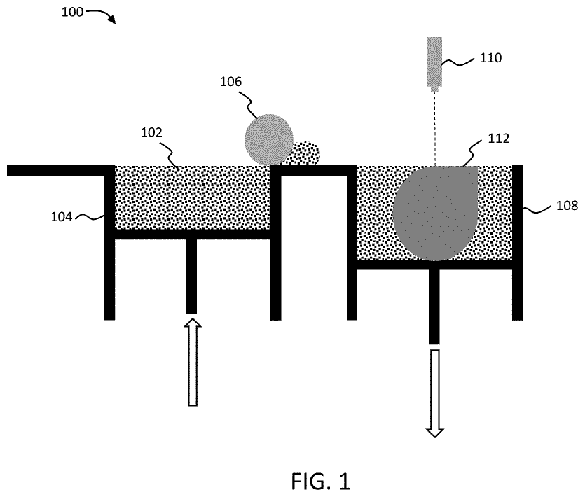

The embodiments disclosed herein may be particularly useful when applied to SLS processes, but it is envisioned that the present disclosure also applies to other powder fusion bed technologies such as, for example, high speed sintering. SLS is an example of a layer-by-layer manufacturing process for producing 3-D shapes, or moldings, by selectively melting and fusing, sintering, targeted regions of the powder layers through directing a focused energy source to the desired regions. FIG. 1 shows a schematic of an example SLS system that may be used in embodiments of the present disclosure. However, it is appreciated that while the present powder composition may be particularly suitable for SLS processes and systems, the present disclosure is not so limited and may be used in other additive manufacturing techniques that use powder based materials. As shown in FIG. 1, in an SLS system 100, powder material 102, typically a thermoplastic polymer, is held in a powder supply container 104. Mechanical equipment 106 distributes a uniform layer of the powder material across a build chamber 108, wherein the equipment directs a laser 110 to the layer of powder material and melts, and/or sinters, the layer in accordance to the desired geometry. Once the layer is sintered, the build chamber 108 lowers by one layer (and the supply container 104 raises by one layer), and the next layer of powder material is distributed over the previously sintered layer of powder material, wherein the subsequent layer is sintered, fusing it to the previous sintered layer. The process is completed layer-by-layer until the article 112 is complete.

Powder flow properties are key to achieve high and homogeneous production quality in the article given the mechanics of the layer-by-layer build. Powder flow properties are a result of the interactions between the individual particles of the powder material. These interactions affect the flow performance in terms of powder density, compressibility, cohesive strength within the particle matrix, and wall friction. The characteristic of powder flowability refers to the manner in which a given powder composition will flow in a particular mechanical equipment configuration. This implies that the same powder material will behave differently in different flow equipment conditions.

In the SLS process, a favorable flowability is useful in achieving smooth, homogeneous and dense successive powder layers with a uniform thickness. Flowability plays a key role in the SLS process because the lack of homogeneous and uniform layers may lead to porous, weak, and overall lower quality SLS products. Moreover, powder with a favorable flowability and a favorable melt flow characteristics during sintering ensures optimal fusion of the powder particles as well as favorable pre-fusion processing.

Powder flowability may be tailored by adjusting the morphology of the powder material, such as the particle sphericity, angularity, and other particle shape parameters. For examples, powder particles with high sphericity may generally demonstrate better flowability and coarse powder particles flow easier than fine powder particles. Although particle size distribution may affect flowability, particle morphology influences flowability more than particle size distribution.

Environmental conditions, such as electrostatic forces, temperature, and humidity, may also generally affect a powder's flowability. Electrostatic forces may come from impurities, crystalline defects, and absorption of gas on the particle matrix. Humidity may also affect electrostatic forces by electrostatically charging the particles. For example, particles tend to charge negatively at high relative humidity. Electrostatic charge build-up during polymer powder handling may also result from prolonged contact, collision, and friction.

Embodiments of the present disclosure are directed to incorporating a stearate additive that is dry blended with a thermoplastic polymer powder for use in additive manufacturing. Incorporation of such additive may positively affect the flowability of the powder material so that a consistent layer of powder may be applied during an additive manufacturing process such as SLS. These additives modify the electrostatic charge of the powder particles, reducing the powder particles micro-agglomerates, and enabling more movement of the powder particles relative to one another.

Stearates as external lubricants may provide at least a layer between the thermoplastic polymer powder and surface of the processing equipment. External lubricants coat the outside of the individual particles of the powder and inhibit the powder particles' adherence the surface of the equipment. In contrast, internal lubricants reduce the effective melt viscosity of the powder at the processing temperatures to improve the flow properties during processing as well as promote fusion. Polymer particles tend to adhere to one another when heated above their melting point. Internal lubricants, i.e., those incorporated into the matrix of the polymer material on a molecular scale, are conventionally in polymer processing reduce the friction between the polymer chains.

However, in accordance with the present disclosure, the inventors seek to optimize flowability of powder material, such as thermoplastic polymer powders, by incorporation of a stearate additive dry blended with the polymer powder to aid in flowability of the powder in layering techniques used in additive manufacturing.

According to embodiments of the present disclosure, a method to improve powder flowability for the SLS process may include dry blending a metal stearate with a thermoplastic polymer powder. In particular, a stearate additive and thermoplastic polymer blend are combined in a dry blend, such as by a batch blend method to create a dry blend mixture. The dry blend mixture is then fed into the SLS process as described above.

According to embodiments of the present disclosure, the size of the metal stearate may be up to 200 microns. The size of the thermoplastic polymer powder may be 50 to 200 microns. In one or more embodiments of the present disclosure, the metal stearate is smaller than or equal to the size of the thermoplastic polymer powder.

In one or more embodiments, the stearate additive may be combined with the thermoplastic polymer powder in an amount ranging from 2,000 ppm to 20,000 ppm. For example, the stearate additive may be present at a lower limit of any of 2,000, 3,000, 5,000, or 8,000 ppm, and an upper limit of any of 10,000, 12,000, 15,000, or 20,000 ppm, where any lower limit can be used in combination with any upper limit.

Thermoplastic polymer powders that may benefit from the improved flowability include polyolefins, ethylene vinyl acetate, and polylactic acid, which may be used with the stearate additives. In one or more embodiments, the thermoplastic polymer powder may include polyolefins selected from polyethylene (including high density polyethylene, ultrahigh molecular weight polyethylene, low density polyethylene, and linear low density polyethylene) and polypropylene.

Polymer blends of the present disclosure may include fillers and additives that modify various physical and chemical properties when added to the polymer composition during blending that include one or more polymer additives such as processing aids, lubricants, antistatic agents, clarifying agents, nucleating agents, beta-nucleating agents, slipping agents, antioxidants, compatibilizers, antacids, light stabilizers such as HALS, IR absorbers, whitening agents, inorganic fillers, organic and/or inorganic dyes, anti-blocking agents, processing aids, flame-retardants, plasticizers, biocides, adhesion-promoting agents, metal oxides, mineral fillers, glidants, oils, anti-oxidants, antiozonants, accelerators, and vulcanizing agents. In some embodiments, fillers and/or additives may be included in the thermoplastic polymer in addition to, or instead of, the polymer blend itself.

### Examples

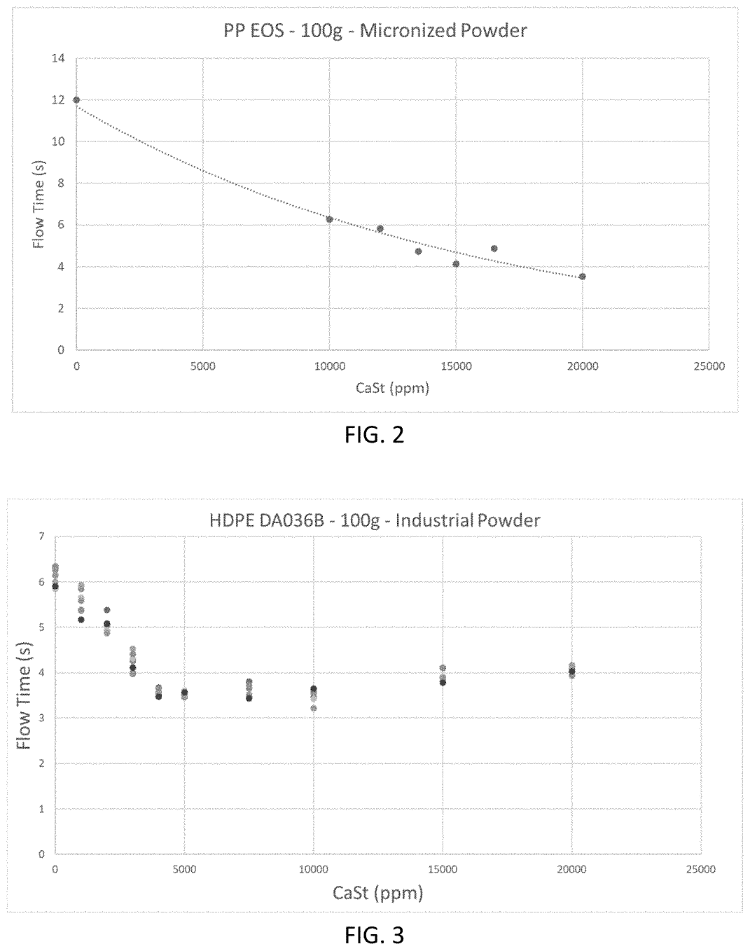

Laboratory dry flow testing showed that using a dry blend method of mixing thermoplastic powder with metal stearate CaSt increased the powder flowability. FIGS. 2-5 shows the average dry powder flow of powdered polypropylene (PP), high-density polyethylene (HDPE), and ultra-high molecular weight polyethylene (UTEC®), when dry blended with increasing amounts of CaSt. The testing procedure was based on the time that the powder composition took to fully drain from a container. The time control used to measure the flow was made using a calibrated chronometer, the test was repeated five times, and the data was captured in the tables shown below. All of the samples were produced adding CaSt neat powder as the metal stearate. There may be some negligible variability due to environmental conditions.

As seen in FIG. 2-5, there is a significant increase in flowability with the higher concentration of CaSt, leading to the reduction in time to drain the powder from the test container. Also, the flowability of the sample polymer powders increases once the concentration of CaSt reaches an effective level. In these examples, the effective amount of CaSt to affect flowability is around at least 2,000 ppm.

According to some embodiments of the present disclosure, PP powder may be dry blended with CaSt in a range of 2,000 to 20,0000 ppm. PP powder dry blended with CaSt in a range of 2,000 to 20,000 ppm exhibits increased and improved flowability, particularly useful when applied to the SLS process described above and shown in FIG. 1. The results of the dry blending of PP powder with CaSt are shown in FIG. 2.

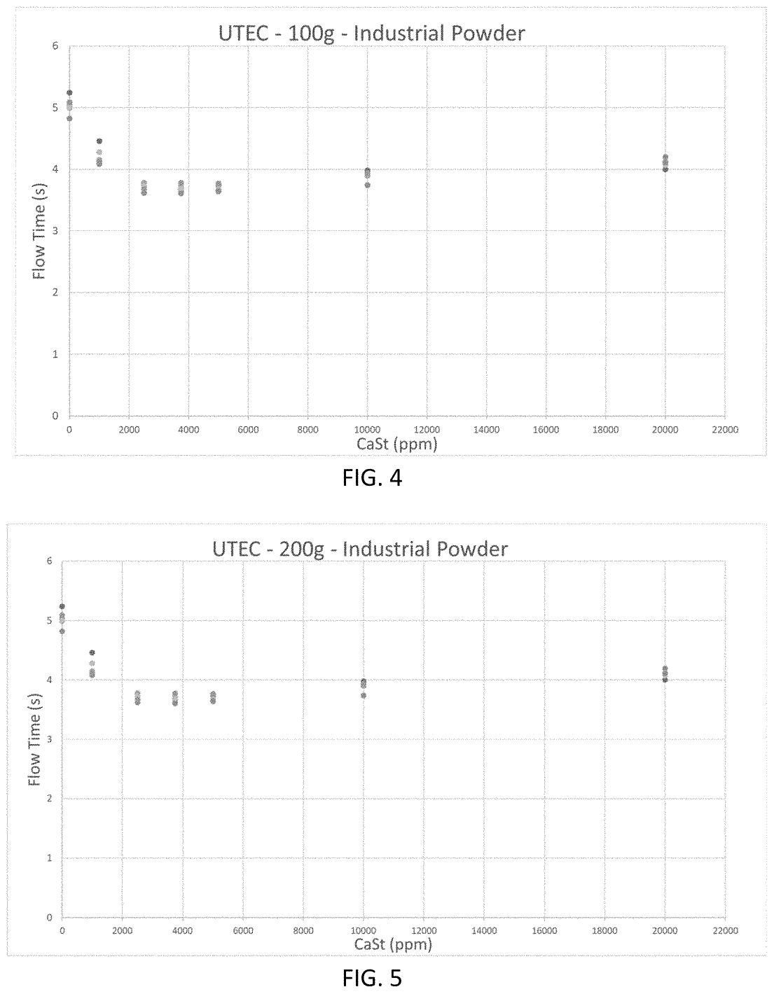

According to embodiments of the present disclosure, HDPE powder may be dry blended with CaSt in a range of 2,000 to 20,000 ppm. HDPE powder dry blended with CaSt in a range of 2,000 to 20,000 ppm exhibits increased and improved flowability, particularly when applied to the SLS process described above and shown in FIG. 1. The results of the dry blending of PP powder with CaSt are shown in FIG. 3. According to embodiments of the present disclosure, UTEC® powder may be dry blended with CaSt in a range of 2,000 to 20,000 ppm. UTEC® powder dry blended with CaSt in a range of 2,000 to 20,000 ppm exhibits increased and improved flowability, particularly when applied to the SLS process described above and shown in FIG. 1. Two tests captured UTEC® flowability data. The first set of test results, as shown in FIG. 4 shows the flowability data from 100 g of UTEC® and increasing addition of CaSt. The second test results, as shown in FIG. 5, shows the flowability data from 200 g of UTEC® and increasing addition of CaSt. As demonstrated by the data of both tests, there is an increase in UTEC® powder flowability by the addition of CaSt via dry blend techniques.

Embodiments of the present disclosure may provide at least of the following advantages. The flowability of the powder material used in layering additive manufacturing processes is improved by using a stearate additive as an external lubricant and blending the stearate additive with dry blend techniques known in the art.

While the disclosure includes a limited number of embodiments, those skilled in the art, and having the benefit of this disclosure, will appreciate that other embodiments may be devised that do not depart from the scope of the present disclosure. Accordingly, the scope should only be limited by the attached claims.

What is claimed:

1. A method of manufacturing an article using a powder bed fusion technique, comprising:
depositing a first layer of a dry blend mixture on to a target surface, the dry blend mixture comprising a thermoplastic polymer powder and a stearate additive in a range of 2,000 ppm to 20,000 ppm;
directing energy to the first layer of the dry blend mixture so as to melt and sinter at least portion of the first layer of the dry blend mixture; and
successively depositing layers of the dry blend mixture and directing energy to the deposited layers so as to melt and sinter at least a portion of the successive layers to a prior layer to perform a layer-by-layer process until a three-dimensional structure is obtained.

2. The method of claim 1, further comprising: dry blending the thermoplastic polymer powder and an effective amount of the stearate additive to produce the dry blend mixture.

3. A method of improving flowability of a thermoplastic polymer powder, comprising:
dry blending a stearate additive in the range of 2,000 ppm to 20,000 ppm with a thermoplastic polymer powder to produce a dry blend mixture; and
causing the dry blend mixture to flow.

4. The method of claim 3, wherein the stearate additive is calcium stearate.

5. The method of claim 3, wherein the thermoplastic polymer powder is a polyolefin.

6. The method of claim 3, wherein the thermoplastic polymer powder is polyethylene.

7. The method of claim 3, wherein the thermoplastic polymer powder is ultra high molecular weight polyethylene.

8. The method of claim 3, wherein the thermoplastic polymer powder is polypropylene.

9. The method of claim 3, wherein the stearate additive has an average particle size up to the average particle size of the thermoplastic polymer powder.

10. The method of claim 3, wherein the stearate additive has an average particle size of up to 200 microns.

11. The method of claim 3, wherein the thermoplastic polymer powder has an average particle size ranging from 50 to 200 microns.

12. The method of claim 3, wherein the stearate additive is present in an amount ranging from 5,000 ppm to 20,000 ppm.

13. The method of claim 3, wherein the stearate additive is present in an amount ranging from 10,000 ppm to 20,000 ppm.

14. A dry blend powder with improved flowability for powder bed fusion techniques, comprising:
a thermoplastic polymer powder, and
a stearate additive in a range of 2,000 to 20,000 ppm.

15. The dry blend powder of claim 14, wherein the stearate additive has an average particle size of up to 200 microns.

16. The dry blend powder of claim 14, wherein the thermoplastic polymer powder has an average particle size ranging from 50 to 200 microns.

17. The dry blend powder of claim 14, wherein the stearate additive is calcium stearate.

18. The dry blend powder of claim 14, wherein the thermoplastic polymer powder is polypropylene.

19. The dry blend powder of claim 14, wherein the thermoplastic polymer powder is polyethylene.

20. The dry blend powder of claim 14, wherein the thermoplastic polymer powder is ultra high molecular weight polyethylene.
